(19) United States
(12) Patent Application Publication
(10) Pub. No.: US 2014/0356406 A1
(43) Pub. Date: Dec. 4, 2014

(54) Antimicrobial Articles and Methods of Making and Using Same

(71) Applicant: CORNING INCORPORATED, CORNING, NY (US)

(72) Inventors: Mallanagouda Dyamanagouda Patil, Corning, NY (US); Christine Coulter Wolcott, Horseheads, NY (US)

(73) Assignee: CORNING INCORPORATED, CORNING, NY (US)

(21) Appl. No.: 14/282,234

(22) Filed: May 20, 2014

Related U.S. Application Data
(60) Provisional application No. 61/829,910, filed on May 31, 2013.

(51) Int. Cl. A01N 59/16; A01N 25/08; C03C 21/00; A01N 59/20

(52) U.S. Cl. CPC A01N 59/16; A01N 59/20; A01N 25/08; C03C 21/001
USPC 424/411; 424/618; 424/641; 424/637; 424/619; 65/30.13; 65/30.14

(57) ABSTRACT

Described herein are glass or glass-ceramic articles having improved antimicrobial efficacy. Further described are methods of making and using the improved articles. The improved articles generally include a glass or glass-ceramic substrate, a compressive stress layer that extends inward from a surface of the glass or glass-ceramic substrate to a first depth therein, and an antimicrobial agent-containing region that extends inward from the surface of the glass or glass-ceramic substrate to a second depth therein. The antimicrobial agent-containing region may include at least one of a plurality of ion exchanged-copper ions and a plurality of ion exchanged-silver ions, arranged in a predetermined portion of the surface.

This application claims the benefit of priority under 35 U.S.C. §119 of U.S. Provisional Application Ser. No. 61/829,910, filed on May 31, 2013, the content of which is relied upon and incorporated herein by reference in its entirety.

### TECHNICAL FIELD

The present disclosure relates generally to antimicrobial articles. More particularly, the various embodiments described herein relate to glass or glass-ceramic articles having improved antimicrobial behavior as well as to methods of making and using the articles.

### BACKGROUND

Touch-activated or -interactive devices, such as screen surfaces (e.g., surfaces of electronic devices having user-interactive capabilities that are activated by touching specific portions of the surfaces), have become increasingly more prevalent. In general, these surfaces should exhibit high optical transmission, low haze, and high durability, among other features. As the extent to which the touch screen-based interactions between a user and a device increases, so too does the likelihood of the surface harboring microorganisms (e.g., bacteria, fungi, viruses, and the like) that can be transferred from user to user.

To minimize the presence of microbes on glass, so-called “antimicrobial” properties have been imparted to a variety of glass articles. Such antimicrobial glass articles, regardless of whether they are used as screen surfaces of touch-activated devices or in other applications, can exhibit poor antimicrobial efficacy under ordinary use conditions despite performing adequately under generally-accepted or standardized testing conditions, can exhibit poor optical or aesthetic properties when exposed to certain conditions during fabrication and/or ordinary use, and/or can be costly to manufacture (e.g., when expensive metals or alloys are used as the antimicrobial agent or when additional steps are required to introduce the antimicrobial agent into or onto the glass). These deficiencies ultimately can make it impractical to implement the antimicrobial glass articles.

In one example, antimicrobial properties are imparted by applying a paste containing silver salts to a glass substrate, which is then allowed to dry and heated to exchange silver ions for alkali ions in the glass substrate surface. In such known examples, once exchanged, reduced and precipitated, atomic silver forms color in the glass substrate. In other examples, silver imparted by silver pastes undergoes “metalizing”, which includes the accumulation of reduced silver metal at the paste/glass interface, thus creating iridescence or mirror-like finishes, which are generally undesirable in some glass or glass-ceramic applications. Metalizing can also occur after the glass substrate with the paste disposed thereon is heated, the paste is removed and the resulting glass substrate is heated in a reducing atmosphere, which indicates an outward migration of silver after the silver has been exchanged into the glass.

There accordingly remains a need for technologies that provide glass or other type articles with improved antimicrobial efficacy under both ordinary use and generally-accepted testing conditions. It would be particularly advantageous if such technologies did not adversely affect other desirable properties of the articles, such as optical or aesthetic properties. It would also be advantageous if such technologies could be produced in a relatively low-cost manner. It is to the provision of such technologies that the present disclosure is directed.

### BRIEF SUMMARY

Described herein are various antimicrobial glass and glass-ceramic articles that have improved antimicrobial efficacy, along with methods for their manufacture and use.

One type of improved antimicrobial article includes a glass or glass-ceramic substrate, a compressive stress layer that extends inward from a surface of the glass or glass-ceramic substrate to a first depth therein, and an antimicrobial agent-containing region that extends inward from the surface of the glass or glass-ceramic substrate to a second depth therein. In such an article, the second depth can be about 5 micrometers to about 200 micrometers. In one or more embodiments, the antimicrobial agent-containing region includes a plurality of ion exchanged-copper ions. The antimicrobial agent may be arranged in a predetermined portion of the surface of the glass or glass-ceramic substrate, which may include a geometric pattern.

This type of antimicrobial article can further include an additional layer disposed on the surface of the substrate. The additional layer can include a reflection-resistant coating, a glare-resistant coating, fingerprint-resistant coating, smudge-resistant coating, a color-providing composition, an environmental barrier coating, or an electrically conductive coating.

In certain implementations of this type of improved antimicrobial article, a compressive stress of the compressive stress layer can be about 200 megapascals to about 1.2 gigapascals, and/or the depth of the compressive stress layer can be greater than or equal to about 25 micrometers and less than or equal to about 100 micrometers.

In some implementations of this type of improved antimicrobial article, the antimicrobial agent can include a cationic monovalent silver species, cationic monovalent copper species, and/or cationic divalent zinc species.

In certain situation, an antimicrobial agent concentration of an outermost 50 nanometers of the antimicrobial agent-containing region is up to about 10 weight percent, based on a total weight of the outermost 50 nanometers of the antimicrobial agent-containing region.

This type of antimicrobial article can exhibit at least a 3 log reduction in a concentration of at least Staphylococcus aureus, Enterobacter aerogenes, and Pseudomomas aeruginosa bacteria under JIS Z 2801 (2000) testing conditions. This type of antimicrobial article can also exhibit at least a 1 log reduction in a concentration of at least Staphylococcus aureus, Enterobacter aerogenes, and Pseudomomas aeruginosa bacteria under modified JIS Z 2801 (2000) testing conditions, wherein the modified conditions comprise heating the antimicrobial glass article to a temperature of about 23 degrees Celsius to about 37 degrees Celsius at a humidity of about 38 percent to about 42 percent for about 24 hours followed by drying for about 6 hours to about 24 hours.

This type of improved antimicrobial glass article can serve as a portion of a touch-sensitive display screen or cover plate for an electronic device, a non-touch-sensitive component of an electronic device, a surface of a household appliance, a surface of medical equipment, a surface of an architectural component, a biological or medical packaging vessel, or a surface of a vehicle component.

One type of method of making an antimicrobial glass article includes providing a glass or glass-ceramic substrate having a compressive stress layer that extends inward from a surface of the glass or glass-ceramic substrate to a first depth, and ion-exchanging an antimicrobial agent from an antimicrobial agent-containing liquid suspension into the glass or glass-ceramic substrate effective to form an antimicrobial agent-containing region that extends inward from the surface of the glass or glass-ceramic substrate to a second depth.

In some cases, the method can also include forming an additional functional layer on at least a portion of the surface of the substrate, wherein the additional functional layer comprises a reflection-resistant coating, a glare-resistant coating, fingerprint-resistant coating, smudge-resistant coating, a color-providing composition, an environmental barrier coating, or an electrically conductive coating.

In some cases, the step of forming the additional functional layer can occur before the step of forming the antimicrobial agent-containing region.

In some cases, providing the glass or glass-ceramic substrate having the compressive stress layer can involve providing the glass or glass-ceramic substrate; and forming the compressive stress layer in the glass or glass-ceramic substrate by thermal tempering or chemical ion exchanging.

In some cases, ion-exchanging the antimicrobial agent from the antimicrobial agent-containing liquid suspension into the glass or glass-ceramic substrate involves contacting at least a portion of the surface of the glass or glass-ceramic substrate with the antimicrobial agent-containing liquid suspension, wherein the antimicrobial agent-containing liquid suspension comprises a plurality of particles of a zeolite dispersed in a solvent, wherein the zeolite comprises the antimicrobial agent disposed within pores of the zeolite; and heating the glass or glass-ceramic substrate and/or the antimicrobial agent-containing liquid suspension to a temperature of less than or equal to about 600 degrees Celsius for a period of less than or equal to about 8 hours. In some cases, the method can further include discontinuing the contacting.

It is to be understood that both the foregoing brief summary and the following detailed description describe various embodiments and are intended to provide an overview or framework for understanding the nature and character of the claimed subject matter.

### BRIEF DESCRIPTION OF THE DRAWINGS

FIG. 1 is an illustration of an exemplary 4A zeolite particle;

FIG. 2A is a top view of an antimicrobial glass article according to one or more embodiments;

FIG. 2B is a cross-sectional view of the antimicrobial glass article shown in FIG. 2A,taken along line 2B-2B;

FIG. 2C is a top view of an antimicrobial glass article according to one or more embodiments;

FIG. 2D is a side view of an antimicrobial glass article according to one or more embodiments;

FIG. 3 is a graph showing the fluorescence of Examples 1A, 4A, 5A, 6A and 7A;

FIG. 4 is a graph showing the compressive stress and depth of compressive stress layer of Examples 8A-13A;

FIG. 5 is a graph showing the depth of silver, sodium and potassium in a glass according to Example 14A;

FIG. 6 is a graph showing the amount of Ag₂O in the surface of the glass (i.e. from the surface to a depth of about 1 μm), according to Example B;

FIG. 7 is a graph showing the concentration of Ag₂O at the surface of glasses (i.e., from the surface to a depth of about 43 nm) according to Examples 1C-4C;

FIG. 8 is a graph showing electron microprobe data for Example 1D, after being heat treated at 500° C. for 5 min in nitrogen;

FIG. 9 are images of Examples 1D after being heat treated at various temperatures; and

FIG. 10 is a graph of wavelength v. absorbance for Examples 1D, after various heat treatments in nitrogen.

### DETAILED DESCRIPTION

Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Described herein are various antimicrobial articles that have improved antimicrobial efficacy both under ordinary use conditions and under generally-accepted testing conditions, along with methods for their manufacture and use. The term “antimicrobial” refers herein to the ability to kill or inhibit the growth of more than one species of more than one type of microbe (e.g., bacteria, viruses, fungi, and the like). In general, the improved articles and methods described herein involve the use of an antimicrobial agent-containing liquid suspension to create an antimicrobial agent-containing region of a controlled depth within the glass or glass-ceramic substrate. The antimicrobial agent-containing region beneficially provides the article with improved antimicrobial efficacy both under ordinary use conditions and under generally-accepted testing conditions. In addition, and as will be described in more detail below, the articles can exhibit appropriate transmission, haze, and/or durability, among other features that may be desired for a particular application.

The improved antimicrobial articles described herein generally include a glass or glass-ceramic substrate, a compressive stress layer or region that extends inward from a surface of the substrate to a first depth, and an antimicrobial agent-containing layer or region comprising an antimicrobial agent that extends inward from a surface of the substrate to a second depth therein.

Throughout this specification, the term “compressive stress layer” shall be used to refer to the layer or region of compressive stress, and the term “antimicrobial agent-containing region” shall be used to refer to the layer or region containing the antimicrobial agent. This usage is for convenience only, and is not intended to provide a distinction between the terms “region” or “layer” in any way.

The choice of glass or glass-ceramic material is not limited to a particular composition, as improved antimicrobial efficacy can be obtained using a variety of glass or glass-ceramic compositions. For example, with respect to glasses, the material chosen can be any of a wide range of silicate, borosilicate, aluminosilicate, or boroaluminosilicate glass compositions, which optionally can comprise one or more alkali and/or alkaline earth modifiers.

By way of illustration, one family of compositions includes those having at least one of aluminum oxide or boron oxide and at least one of an alkali metal oxide or an alkali earth metal oxide, wherein −15 mol %≦(R₂O+R′O—Al₂O₃—ZrO₂)—B₂O₃≦4 mol %, where R can be Li, Na, K, Rb, and/or Cs, and R′ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. patent application Ser. No. 12/277,573 by Matthew J. Dejneka et al., entitled “Glasses Having Improved Toughness And Scratch Resistance,” filed Nov. 25, 2008, and claiming priority to U.S. Provisional Patent Application No. 61/004,677, filed on Nov. 29, 2008, the contents of which are incorporated herein by reference in their entireties as if fully set forth below.

Another illustrative family of compositions includes those having at least 50 mol % SiO₂ and at least one modifier selected from the group consisting of alkali metal oxides and alkaline earth metal oxides, wherein [(Al₂O₃ (mol %)+B₂O₃(mol %))/(Σalkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described in more fully in U.S. patent application Ser. No. 12/858,490 by Kristen L. Barefoot et al., entitled “Crack And Scratch Resistant Glass and Enclosures Made Therefrom,” filed Aug. 18, 2010, and claiming priority to U.S. Provisional Patent Application No. 61/235,767, filed on Aug. 21, 2009, the contents of which are incorporated herein by reference in their entireties as if fully set forth below.

Yet another illustrative family of compositions includes those having SiO₂, Al₂O₃, P₂O₅, and at least one alkali metal oxide (R₂O), wherein 0.75≦[(RP₂O₅(mol %)+R₂O(mol %))/M₂O₃ (mol %)]≦1.2, where M₂O₃═Al₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010, the contents of which are incorporated herein by reference in their entireties as if fully set forth below.

Yet another illustrative family of compositions includes those having at least about 4 mol % P₂O₅, wherein (M₂O₃(mol %)/RₓO(mol %))<1, wherein M₂O₃═Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. Provisional Patent Application No. 61/560,434 by Timothy M. Gross, entitled “Ion Exchangeable Glass with High Crack Initiation Threshold,” filed Nov. 16, 2011, the contents of which are incorporated herein by reference in their entirety as if fully set forth below.

Still another illustrative family of compositions includes those having Al₂O₃, B₂O₃, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO₂; at least about 10 mol % R₂O, wherein R₂O comprises Na₂O; Al₂O₃, wherein −0.5 mol %≦Al₂O₃(mol %)−R₂O(mol %)≦2 mol %; and B₂O₃, and wherein B₂O₃(mol %)−(R₂O(mol %)−Al₂O₃(mol %))≧4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≦MgO+ZnO≦6 mol %; and, optionally, at least one of CaO, BaO, and SrO, wherein 0 mol %≦CaO+SrO+BaO≦2 mol %. Such glasses are more fully described in U.S. Provisional Patent Application No. 61/653,485 by Matthew J. Dejneka et al., entitled “Ion Exchangeable Glass with High Damage Resistance,” filed May 31, 2012, the contents of which are incorporated herein by reference in their entirety as if fully set forth below.

Similarly, with respect to glass-ceramics, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The substrate can adopt a variety of physical forms. That is, from a cross-sectional perspective, the substrate can be flat or planar, or it can be curved and/or sharply-bent. Similarly, it can be a single unitary object, a multi-layered structure, or a laminate.

Regardless of its composition or physical form, the substrate will include a layer or region under compressive stress that extends inward from a surface of the substrate to a specific depth therein (i.e., the “first depth”). This compressive stress layer can be formed from a strengthening process (e.g., by thermal tempering, chemical ion-exchange, or like processes). The amount of compressive stress (CS) and the depth of the compressive stress layer (DOL) can be varied based on the particular use for the article, with the proviso that the CS and DOL should be limited such that a tensile stress created within the substrate as a result of the compressive stress layer does not become so excessive as to render the article frangible.

In addition, the substrate will include an antimicrobial agent-containing layer or region that extends inward from a surface of the substrate to a specific depth therein (i.e., the “second depth”). The antimicrobial agent can be chosen from any of a variety of metal-based species that provide antimicrobial behavior, examples of which include cationic monovalent silver (Ag⁺), cationic monovalent copper (Cu⁺), cationic divalent zinc (Zn²⁺), and the like. The antimicrobial agent-containing region comprises the antimicrobial agent in an amount effective to impart antimicrobial behavior to the glass or glass-ceramic article. In general, the antimicrobial agent-containing region, like the compressive stress layer, extends inward from the surface of the substrate. Thus the antimicrobial agent-containing region at least partially overlaps with the compressive stress layer. The depth of the antimicrobial agent-containing region (DOR) will generally be limited so as to avoid undesirable visible coloration in the article and to maximize the antimicrobial efficacy of the antimicrobial agent within the substrate.

In certain implementations, the antimicrobial articles can include an additional functional layer disposed on the surface of the substrate. The optional additional layer(s) can be used to provide additional features to the antimicrobial article (e.g., reflection resistance or anti-reflection properties, glare resistance or anti-glare properties, fingerprint resistance or anti-fingerprint properties, smudge resistance or anti-smudge properties, color, opacity, environmental barrier protection, electronic functionality, and/or the like). Materials that can be used to form the optional additional layer(s) generally are known to those skilled in the art to which this disclosure pertains. By way of example, in one implementation, the optional additional layer might include a coating of SiO₂ nanoparticles bound to at least a portion of the substrate to provide reflection resistance to the final article. In another implementation, optional additional layer might comprise a multi-layered reflection-resistant coating formed from alternating layers of polycrystalline TiO₂ and SiO₂. In another implementation, the optional additional layer might comprise a color-providing composition that comprises a dye or pigment material. In another implementation, the optional additional layer might comprise a fingerprint-resistant coating formed from a hydrophobic and oleophobic material, such as a fluorinated polymer or fluorinated silane. In yet another implementation, the optional additional layer might comprise a smudge-resistant coating formed from an oleophilic material.

Methods of making the above-described articles generally include the steps of providing a substrate, forming a compressive stress layer that extends inward from a surface of the substrate to a first depth, and forming an antimicrobial agent-containing region that extends inward from the surface of the substrate to a second depth. In those embodiments where the optional additional layer is implemented, the methods generally involve an additional step of forming the additional layer on at least a portion of the surface of the substrate.

The selection of materials used in the glass or glass-ceramic substrates, antimicrobial agent, and optional additional layers can be made based on the particular application desired for the final article. In general, however, the specific materials will be chosen from those described above.

Provision of the substrate can involve selection of a glass or glass-ceramic object as-manufactured, or it can entail subjecting the as-manufactured glass or glass-ceramic object to a treatment in preparation for forming the compressive stress layer, the antimicrobial agent-containing region, or the optional functional layer. Examples of such pre-coating treatments include physical or chemical cleaning, physical or chemical etching, physical or chemical polishing, annealing, shaping, and/or the like. Such processes are known to those skilled in the art to which this disclosure pertains.

Once the substrate has been selected and/or prepared, the compressive stress layer can be formed therein. Formation of the compressive stress layer can be accomplished in a variety of ways, of which thermal tempering and chemical ion exchange are the most common. Such techniques are known to those skilled in the art to which this disclosure pertains.

Once the substrate with the compressive stress layer has been formed, the antimicrobial agent-containing region can be formed. This can be accomplished via ion exchange of the antimicrobial agent from an antimicrobial agent-containing liquid suspension that is contacted with at least a portion of the surface of the substrate.

The antimicrobial agent-containing liquid suspension generally includes particles of a zeolite or other porous aluminosilicate molecular sieve, which contains the antimicrobial agent, or a precursor to the antimicrobial agent, dispersed in a solvent. The antimicrobial agent or precursor thereof generally is located within the pores of the zeolite (or molecular sieve), rather than within the framework of the zeolite structure to ensure more facile exchange into the glass or glass-ceramic substrate.

The zeolite particles may have a high cation exchange capacity (“CEC”), for example, about 2 meq/g or greater, in the range from about 2 meq/g to about 5 meq/g. In some embodiments, the zeolite particles may be modified such that they include sodium, potassium and/or calcium in the internal structure thereof. In one or more specific embodiments, the modified zeolite particles may include reducing agents such as iron gluconate or SnCl, which may be useful where multivalent ions (e.g., copper) are used.

In one or more embodiments, the particles have an average longest cross-sectional dimension of less than or equal to about 50 micrometers (gm). In some embodiments, the particles may have an average longest cross-sectional dimension of less than or equal to about 40 μm, 30 μm, 20 μm, 10 μm, 5 μm, 4 μm, 3 μm, 2 μm, or 1 μm. In one or more embodiments, the particles may have a surface area of about 300 m²/g or greater or about 600 m²/g or greater. In some instances, the particles may have a surface area of about 700 m²/g or greater, 800 m²/g or greater, 900 m²/g or greater and all ranges and sub-ranges therebetween. The upper limit of the surface area of the particles is not limited but may, in some instances, include 2000 m²/g.

The particles are dispersed in the solvent, which effectively serves as a mechanism to spread the suspension evenly over the surface of the substrate. In some embodiments, amount of particles in the solvent may be in the range form about 5 wt % to about 60 wt % or from about 10 wt % to about 30 wt %.

The solvent used in the antimicrobial agent-containing solution can be chosen from any of a variety of solvents, with the proviso that the solvent does not adversely affect (e.g., react with, decompose, volatilize, or the like) the substrate, the compressive stress layer, the optional additional functional layer(s) or the zeolite. Examples of such solvents include water, alcohols (e.g., methanol, ethanol, propanol, butanol, and the like), polar aprotic solvents (e.g., tetrahydrofuran, ethyl acetate, acetone, dimethylformamide, acetonitrile, dimethyl sulfoxide, methylpyrrolidone, and the like), oils, and the like.

In certain cases, it may be desirable to include additional components in the antimicrobial agent-containing liquid suspension. For example, as will be discussed in greater detail below, the antimicrobial agent-containing liquid suspension can further include particles of a zeolite or other porous aluminosilicate molecular sieve that contains an alkali metal cation ion exchanged therein, such that the alkali metal cation can ion exchange into the substrate to alter the stress profile of the compressive stress layer. Such cations can also synergistically enhance the antimicrobial efficacy of the final article. In certain examples, the antimicrobial agent-containing liquid suspension can include a viscosity modifier, rheology modifier, stabilizer, surfactant, wetting agent, pH modifier, or the like for enhancing the shelf life, viscosity, flow, wettability, drying rate, and the like of the antimicrobial agent-containing liquid suspension. The antimicrobial agent-containing liquid suspension of one or more embodiments may include a binder, which may be used when a higher viscosity suspension is desired (e.g., when the suspension is to be applied view slot die coating processes). Examples of suitable binders that may be included in the antimicrobial agent-containing liquid suspension include water soluble natural gums (e.g., gum Arabic) and oils (e.g., pine oil).

In one or more embodiments, the antimicrobial agent-containing suspension may optionally include a metal salt or metal oxide. The metal salt or metal oxide may be admixed (where oil solvent is utilized) or dissolved (where an aqueous solvent is utilized). The salt component may penetrate the particles when the antimicrobial agent-containing liquid suspension is contacted with the substrate (as will be described below). Without being bound by theory, where higher concentrations of antimicrobial agents and/or alkali metal cation ions are used, the metal salt(s) in the antimicrobial agent-containing suspension may enhance the exchange of the antimicrobial agent and/or alkali metal cation ions from the particles into the substrate. It is believed that the metal salts provide an electrolyte medium for transport of the antimicrobial agent and/or alkali metal cation ions from the particles into the substrate and alkali metal cation ions (e.g., sodium) from the substrate into the particles.

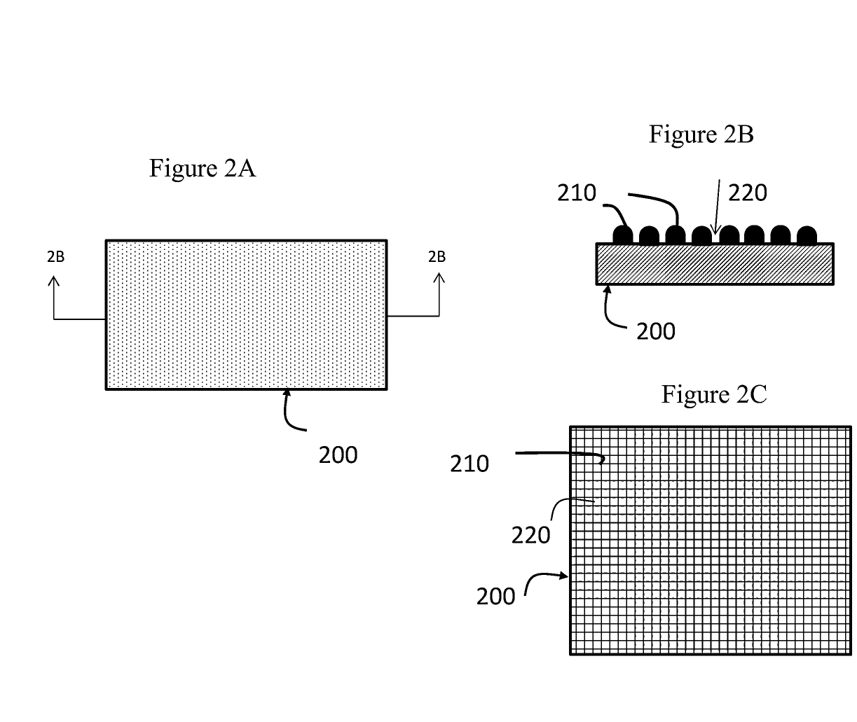

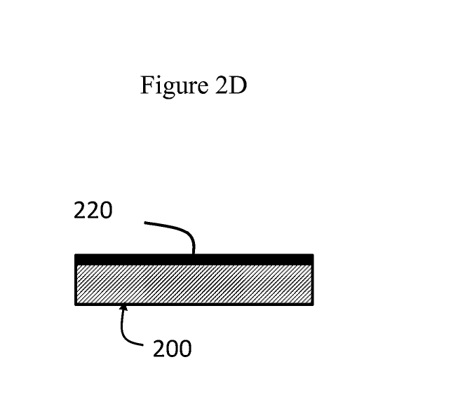

Once the antimicrobial agent-containing liquid suspension is formed or selected, it can be contacted with the substrate. Such contacting can take the form of partial or complete immersion of the substrate in the antimicrobial agent-containing liquid suspension, spraying the antimicrobial agent-containing liquid suspension on the surface of the substrate, dip-coating the antimicrobial agent-containing liquid suspension on the surface of the substrate, spin-coating the antimicrobial agent-containing liquid suspension on the surface of the substrate, slot-coating the antimicrobial agent-containing liquid suspension on the surface of the substrate, inkjetting the antimicrobial agent-containing liquid suspension on the surface of the substrate, and/or the like. The antimicrobial agent-containing liquid suspension may be applied to a portion of the substrate such as shown in FIGS. 2A-2C, and may be applied in a predetermined pattern. In FIG. 2A, the substrate 200 includes a surface on which the antimicrobial agent-containing liquid suspension is applied as a pattern. FIG. 2B shows the cross-sectional view of the substrate 200 shown in FIG. 2A along lines 1B-1B showing areas where the antimicrobial agent-containing liquid suspension 210 is applied to the substrate and areas 220 of the substrate that are free of the antimicrobial agent-containing liquid suspension. In the embodiments shown in FIGS. 2A-2B, the antimicrobial agent-containing liquid suspension is applied in isolated drops or islands. FIG. 2C shows the top view of an embodiment in which the antimicrobial agent-containing liquid suspension is applied in a grid pattern. FIG. 2D shows a cross-sectional view a substrate 200 with the antimicrobial agent-containing liquid 220 applied over the entire surface of the substrate.

The contacting step can also include a heating component, wherein the antimicrobial agent-containing liquid suspension and/or substrate are heated (e.g., via resistive heating, convection, infrared heating, dielectric heating, and the like) to enable better ion exchange of the antimicrobial agent into the glass or glass-ceramic substrate. In many implementations, the heating temperature will be less than or equal to about 600 degrees Celsius (° C.). In one or more embodiments, the heating component may include heating the antimicrobial agent-containing liquid suspension and/or substrate to a temperature in the range from about 80° C. to about 100° C. In some embodiments, the substrate may be heated to a temperature in the range from about 80° C. to about 100° C. during the contacting step. The duration of the contacting step will be less than or equal to about 8 hours, but in most implementations will be less than or equal to about 4 hours.

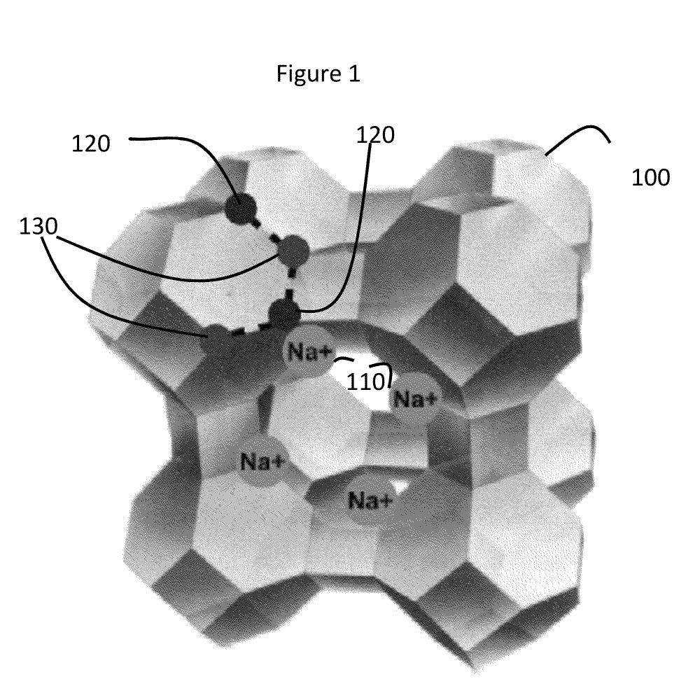

In one or more embodiments, during the contacting step, the antimicrobial agent migrates from the particles into the substrate. In embodiments where the substrate includes alkali, the antimicrobial agent migrates from the particles in an exchange with the alkali ions (e.g., sodium) in the substrate. The alkali ions from the substrate may migrate into the open areas of the particles. For example, where the particles include zeolite, sodium ions from the substrate (which may include glass) may migrate and be held or sequestered in the zeolite cages, instead of accumulating on the substrate surface. This specific migration and sequestration prevents excessive sodium poisoning of the anti-microbial agent-alkali exchange reaction and/or prevents metallization of the anti-microbial agent. FIG. 1 shows an exemplary image of 4A Na-zeolite structure 100 having an internal surface and high surface area. Sodium ions 110 are shown within a channel of the zeolite structure. Aluminum 120 and silicon 130 are also shown, which are both in tetrahedral structure sharing an oxygen atom between each bond. The sodium ions 110 are close to the aluminum site to compensate charge for AlO₄⁻.

Upon completion of the contacting step, the remaining antimicrobial agent-containing liquid suspension or residue thereof should be removed from the surface of the glass or glass-ceramic substrate. This can be accomplished by mechanical (e.g., air knife, brushing, rubbing, or the like) or chemical means (e.g., a solvent or cleaning material).

The resulting anti-microbial agent-containing region may impart anti-microbial efficacy to the substrate and may also impart changes in ultra-violet and/or visible absorbance, refractive index and may add fluorescence to the substrate. In other embodiments, where the antimicrobial agent-containing liquid suspension is applied to only a portion of the substrate (e.g., in a pattern), the texture of the substrate may be modified by the resulting anti-microbial agent containing-region and thus the substrate may exhibit greater or less gloss at the anti-microbial agent-containing region, when compared to other regions of the substrate that do not include the antimicrobial agent-containing region.

In one or more embodiments, the method may include forming a compressive stress in the substrate before or after forming the antimicrobial agent-containing region. The compressive stress may be formed by an ion exchange process, which may be carried out by applying a suspension of particles, as described herein, which include an alkali metal cation ion exchanged therein, such that the alkali metal cation can ion exchange into the substrate to alter the stress profile of the compressive stress layer typically used for creating compressive stress in substrates. For example, the alkali metal cation(s) may include Li⁺, Na⁺, K⁺, Rb⁺, and/or Cs⁺ ions. In some embodiments, the antimicrobial agent-containing liquid suspension including alkali metal cation(s) is applied to the substrate such that the compressive stress layer and the antimicrobial agent-containing region are formed at about the same time. The amount of particles in the solvent used to form the suspension may be in the range form about 5 wt % to about 60 wt % or from about 10 wt % to about 30 wt %.

In one or more embodiments, the compressive stress may be formed in the substrate by an ion exchange process that includes immersing the substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the substrate and the desired depth of layer and compressive stress of the substrate that result from the ion exchange process. By way of example, ion exchange of alkali metal-containing glass substrates may be achieved by immersion in at least one molten bath containing a salt such as, but not limited to, nitrates, sulfates, and chlorides of the larger alkali metal ion (e.g., KNO₃, NaNO₃ and combinations thereof). The temperature of the molten salt bath may be in a range from about 380° C. up to about 450° C., while immersion times range from about 15 minutes up to about 40 hours. However, temperatures and immersion times different from those described above may also be used.

After the antimicrobial agent-containing region is formed, the optional additional functional layer can be disposed on the surface of the substrate, if desired. Depending on the materials chosen, the optional additional layer(s) can be disposed or formed on the surface of the substrate using a variety of techniques. For example, the optional additional layer(s) can be fabricated independently using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like), spray coating, spin-coating, dip-coating, inkjetting, sol-gel processing, or the like. Such processes are known to those skilled in the art to which this disclosure pertains.

It should be noted that between any of the above-described steps, the substrate can undergo a treatment in preparation for any of the subsequent steps. As described above, examples of such treatments include physical or chemical cleaning, physical or chemical etching, physical or chemical polishing, annealing, shaping, and/or the like.

Once the article is formed, it can be used in a variety of applications where the article will come into contact with undesirable microbes. These applications encompass touch-sensitive display screens or cover plates for various electronic devices (e.g., cellular phones, personal data assistants, computers, tablets, global positioning system navigation devices, and the like), non-touch-sensitive components of electronic devices, surfaces of household appliances (e.g., refrigerators, microwave ovens, stovetops, oven, dishwashers, washers, dryers, and the like), medical equipment, architectural applications, biological or medical packaging vessels, and vehicle components, just to name a few devices.

Given the breadth of potential uses for the improved antimicrobial articles described herein, it should be understood that the specific features or properties of a particular article will depend on the ultimate application therefor or use thereof. The following description, however, will provide some general considerations.

There is no particular limitation on the average thickness of the substrate contemplated herein. In many exemplary applications, however the average thickness will be less than or equal to about 25 millimeters (mm). If the antimicrobial article is to be used in applications where it may be desirable to optimize thickness for weight, cost, and strength characteristics (e.g., in electronic devices, or the like), then even thinner substrates (e.g., less than or equal to about 5 mm) can be used. By way of example, if the antimicrobial article is intended to function as a cover glass for a touch screen display, then the glass substrate can exhibit an average thickness of about 0.02 mm to about 2.0 mm.

While the ultimate limit on the CS and DOL is the avoidance of rendering the substrate frangible, the average DOL of the compressive stress layer generally will be less than about one-third of the thickness of the substrate. The CS and DOL can be measured using a surface stress meter, which is an optical tool that generally uses the photoelastic constant and index of refraction of the substrate material itself, and converts the measured optical interference fringe patterns to specific CS and DOL values. In most applications, the average DOL will be greater than or equal to about 25 μm and less than or equal to about 100 μm. Similarly, the average CS across the depth of the compressive stress layer generally will be between about 200 megapascals (MPa) and about 1.2 gigapascals (GPa). In most applications, the average CS will be greater than 400 MPa.

As with the DOL of the compressive stress layer, the average thickness of the antimicrobial agent-containing region generally will be less than about one-third of the thickness of the substrate. The exact thickness, however, will vary depending on how the antimicrobial agent-containing region is formed (i.e., the DOR can be tailored to a specific level based on the time and extent of the contacting the amount of antimicrobial agent located within the pores of the zeolite, and/or the number of particles in the antimicrobial agent-containing liquid suspension. In most applications, the average DOR will be greater than or equal to about 5 μm and less than or equal to about 200 μm. Within this region, silver concentrations at the outermost portion of this region (which includes about the outermost 50 nanometers (nm)) of up to about 10 weight percent (wt %), based on the total weight of this portion of the region, can be attained as measured using, for example, electron microprobe analysis.

When an optional additional layer is used, the average thickness of such a layer will depend on the function it serves. For example if a glare- and/or reflection-resistant layer is implemented, the average thickness of such a layer should be less than or equal to about 200 nm. Coatings that have an average thickness greater than this could scatter light in such a manner that defeats the glare and/or reflection resistance properties. Similarly, if a fingerprint- and/or smudge-resistant layer is implemented, the average thickness of such a layer should be less than or equal to about 100 nm.

In general, the optical transmittance of the antimicrobial article will depend on the type of materials chosen. For example, if a glass substrate is used without any pigments added thereto and/or any optional additional layers are sufficiently thin, the article can have a transparency over the entire visible spectrum of at least about 85%. In certain cases where the antimicrobial article is used in the construction of a glass touch screen for an electronic device, for example, the transparency of the antimicrobial glass article can be at least about 90% over the visible spectrum. In situations where the substrate comprises a pigment (or is not colorless by virtue of its material constituents) and/or any optional additional layers are sufficiently thick, the transparency can diminish, even to the point of being opaque across the visible spectrum. Thus, there is no particular limitation on the optical transmittance of the antimicrobial article itself

Like transmittance, the haze of the antimicrobial article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the antimicrobial article is used in the construction of a glass touch screen for an electronic device, the haze of the article can be less than or equal to about 5%.

Regardless of the application or use, the antimicrobial articles described herein offer high antimicrobial efficacy. The antimicrobial activity and efficacy can be measured in accordance with Japanese Industrial Standard JIS Z 2801 (2000), entitled “Antimicrobial Products-Test for Antimicrobial Activity and Efficacy,” the contents of which are incorporated herein by reference in their entirety as if fully set forth below. Under the “wet” conditions of this test (i.e., about 37° C. and greater than 90% humidity for about 24 hours), the antimicrobial articles described herein can exhibit at least a 3 log reduction in the concentration (or a kill rate of 99.999%) of at least Staphylococcus aureus, Enterobacter aerogenes, and Pseudomomas aeruginosa bacteria. In certain implementations, the antimicrobial articles described herein can exhibit at least a 5 log reduction in the concentration of any bacteria to which it is exposed under these testing conditions.

In scenarios where the wet testing conditions of JIS Z 2801 do not reflect actual use conditions of the antimicrobial articles described herein (e.g., when articles are used in electronic devices, or the like), the antimicrobial activity and efficacy can be measured using “drier” conditions. For example, the articles can be tested between about 23 and about 37° C. and at about 38 to about 42% humidity for about 24 hours. Specifically, 5 control samples and 5 test samples can be used, wherein each sample has a specific inoculum composition and volume applied thereto, with a sterile coverslip applied to the inoculated samples to ensure uniform spreading on a known surface area. The covered samples can be incubated under the conditions described above, dried for about 6 to about 24 hours, rinsed with a buffer solution, and enumerated by culturing on an agar plate, the last two steps of which are similar to the procedure employed in the JIS Z 2801 test. Using this test, the antimicrobial articles described herein can exhibit at least a 1 log reduction in the concentration (or a kill rate of 90%) of at least Staphylococcus aureus bacteria and at least a 2 log reduction in the concentration (or a kill rate of 99.99%) of at least Enterobacter aerogenes, and Pseudomomas aeruginosa bacteria. In certain implementations, the antimicrobial articles described herein can exhibit at least a 3 log reduction in the concentration of any bacteria to which it is exposed under these testing conditions.

In other scenarios where the wet testing conditions of JIS Z 2801 do not reflect actual use conditions of the antimicrobial articles described herein (e.g., when the glass articles are used in electronic devices, or the like), the antimicrobial activity and efficacy can be measured using “dry” conditions. These conditions described herein are collectively referred to herein as a “Dry Test”. The antimicrobial articles may exhibit at least a 1 log reduction in the concentration (or a kill rate of 90%) or even at least a 2 log reduction in the concentration (or kill rate of 99%) of at least Staphylococcus aureus, Enterobacter aerogenes, and Pseudomomas aeruginosa bacteria when tested under the Dry Test, which is described in U.S. Provisional Patent Application No. 61/908,401, which is hereby incorporated by reference in its entirety as if fully set forth below.

In a specific embodiment that might be particularly advantageous for applications such as touch-accessed or -operated electronic devices, an antimicrobial glass article is formed from a chemically strengthened (ion exchanged) alkali aluminosilicate flat glass sheet. The average thickness of the glass sheet is less than or equal to about 1 mm, the average DOL of the ion exchanged compressive stress layer on each major surface of the glass sheet will be about 40 μm to about 100 μm, and the average CS across the depth of the compressive stress layer on each major surface will be about 400 MPa to about 1.1 GPa. The average thickness of the antimicrobial agent-containing region, which is formed by an ion exchange step (using an aqueous silver containing zeolite suspension that is sprayed onto the flat glass sheet and heated at to about 400° C. for about 2 hours) after the compressive stress layer is formed, will be about 50 μm to about 200 μm. This antimicrobial glass article can have an optical transmittance of at least about 90% across the visible spectrum and a haze of less than 1%.

In certain cases, one of the major surfaces of the glass sheet can have an anti-reflection coating, an anti-fingerprint coating, and/or a color-providing coating disposed on at least a portion thereof. Such an antimicrobial glass article can be used in the fabrication of a touch screen display for an electronic device, offering desirable strength, optical properties, and antimicrobial behavior. In addition, such an antimicrobial glass article can exhibit at least a 3 log reduction in the concentration of any bacteria to which it is exposed under the testing conditions of JIS Z 2801 and at least a 1 log reduction in the concentration of any bacteria to which it is exposed under the drier testing conditions of the modified JIS Z 2801 test described above.

### EXAMPLES

In the Examples 1A-14A, B and 1C-4C below, the antimicrobial agent-containing suspension was formed by forming Na-zeolite (molecular sieve 4A or molecular sieve 3A) particles by exposing the zeolite particles to a salt solution including silver with agitation, separating the liquid and solid and drying the Ag-zeolite particles in a convection oven at 100° C. The Ag-zeolite particles were then combined with a solvent to form the antimicrobial agent-containing suspension. The suspension included an optional metal salt (e.g., ZnS, CuSO₄ or AgNO₃) and/or optionally other zeolite particles (e.g., K-zeolite particles and/or Na-zeolite particles). The suspension was mixed by vortex or planetary mixing.

Where the suspension is contacted with the substrate via spray coating, the suspension was blended with various amounts of 10 wt % gum Arabic in water. The suspension was then applied to substrates using a hand sprayer, allowing for hot air drying between each application or coating. Where film application is used to contact the suspension with the substrate, squeegee oil provided by Reusche or 100% gum Arabic was used as a binder. The contacted suspension was then dried at room temperature or in a 50° C. convection oven, followed by placing in a furnace with exhausted air or a furnace with flowing nitrogen at 20 psi. The furnace temperature was increased at 10° C./minute to a temperature 25° C. below the maximum hold temperature and then increased at 0.8° C./minute to the maximum hold temperature, where the substrate in contact with the antimicrobial agent-containing suspension was held for 5 minutes (unless otherwise stated) and then cooled to room temperature at a rate of about 40° C./minute.

In the following Examples, some of the substrates included glass substrates having a thickness of about 0.7 mm having a composition of about 64-66 wt % SiO₂, 1-14 wt % Al₂O₃, 11-14 wt % Na₂O, 1-2 wt % K₂O, 4-5 wt % MgO, less than 1 wt % CaO and less than 1 wt % SnO₂. The glass substrates did not include a compressive stress layer. Prior to contacting the substrates with the antimicrobial agent-containing suspension, the substrates were cleaned using a detergent solution or wiped with ethanol.

After contacting the substrate with the antimicrobial agent-containing suspension, the suspension was dried as described herein, and removed as described herein. The resulting article was then evaluated under the two different antimicrobial efficacy tests. One test involved “wet” conditions (according to the JIS Z 2801 test), and the other involved “drier” conditions (according to the modified JIS Z 2801 test). For the “wet” test according to JIS Z 2801, cultured gram negative E. coli; DHSalpha-Invitrogen Catalog No. 18258012, Lot No. 7672225, rendered Kanamycin resistant through a transformation with PucI9 (Invitrogen) plasmid, were utilized. The bacteria culture was started using either LB Kan Broth (Teknova #L8145) or Typtic Soy Broth (Teknova # T1550). Approximately 2 μl of overnight cultured liquid bacteria suspension or a pipette tip full of bacteria were streaked from an agar plate and dispensed into a capped tube containing 2-3 ml of broth and incubated overnight at 37° C. in a shaking incubator. The next day the bacteria culture was removed from the incubator and washed twice with PBS. The optical density (OD) was measured and the cell culture was diluted to a final bacterial concentration of approximately 1×10⁵ CFU/ml. The cells were placed on the article surface and a glass surface control (having dimensions of about 1″×1″), covered with Parafilm and incubated for 6 hours at 37° C. with saturated humidity. Afterward, the buffers from each surface were collected and the plates were twice washed with ice-cold PBS. For each well the buffer and wash were combined and the surface spread-plate method was used for colony counting.

For the “drier” test according to the modified JIS Z 2801 test, each article was placed into petri dish in triplicate. Glass slides not contacted with the antimicrobial agent-containing suspension were used as negative controls. Gram positive Staphylococcus aureus bacterial were cultured for at least 3 consecutive days before, on the day of testing, the inocula has been culture for at least 48 hours. The bacterial culture was vortexed and allowed to stand for 15 minutes. Thereafter, a serum (with 5% final concentration) and Triton X-100 (with a 0.01% final concentration) were added to the inocula. Each of the samples (including the articles and the controls) were inoculated with 10 ul aliquot of the bacterial suspension, and allowed to dry for 30˜40 minutes in room temperature, at 42% relative humidity. After the samples are dried, a two-hour exposure time to count begins. After the two-hour exposure time, 4 ml of PBS buffer was added into each petri dish. After shaking, all the solution from each petri dish was collected and placed onto Trypticase soy agar plate. After an additional 24-hour incubation period at 37° C. in an incubator, bacteria colony formation was examined. Geometric mean and percent reduction were calculated based on the colony number on glass and control glass.

Where the article passed the modified JIS Z 2801 test, it was assumed the article also passed the less rigid JIS Z 2801 test. In some examples, UV-vis absorbance was evaluated, and the articles were subjected to fluorescence testing using Alphalnnotech MultiImage III Fluorochem Q. This method provides an average relative fluorescent unit (RFU) for each sample. The settings used were 10s exposure and 242 pixel sample area. The samples were also evaluated by Elemental line scans using electron microprobe (EMP) in both standard mode and accelerating potential mode. The compressive stress layer was evaluated for compressive strength (CS) and depth of compressive stress layer (DOL) using FSM.

### Examples 1A-14A

Examples 1A-7A were prepared by forming antimicrobial agent-containing suspensions and contacting glass substrates with the suspensions. The antimicrobial agent-containing suspensions were formed by batching Ag-zeolite particles with the components provided in Table 1 below. The glass substrates were then contacted with the antimicrobial agent-containing suspensions, which were sprayed or applied as a film onto the glass substrates, and heated for 5-15 minutes at temperatures in the range from about 250° C. to about 600° C.

TABLE 1
Antimicrobial agent-containing suspensions
used to form Examples 1A-7A.

| Ex- | | | 10% | | | | | | |
|---|---|---|---|---|---|---|---|---|---|
| am- | Ag- | | gum | Squeegee | | | Metal salt(s) | | |
| ple | zeolite | | Arabic | oil | | Water | ZnS | CuSO₄ | AgNO₃ |
| 1A | 5 | g | 10 g | — | | — | — | — | — |
| 2A | 5 | g | 10 g | — | | — | 0.5 g | — | — |
| 3A | 5 | g | 10 g | — | | — | — | 1.5 g | — |
| 4A | 5 | g | 10 g | — | | — | — | — | — |
| 5A | 20 | g | 28 g | 15.4 | g | — | — | — | 20 g |
| 6A | 5 | g | 20 g | — | | 13 g | — | — | 20 g |
| 7A | 14 | g | — | 10 | g | — | — | — | — |

After the glass substrates were contacted with the antimicrobial agent-containing suspensions, the antimicrobial agent-containing suspensions were removed.

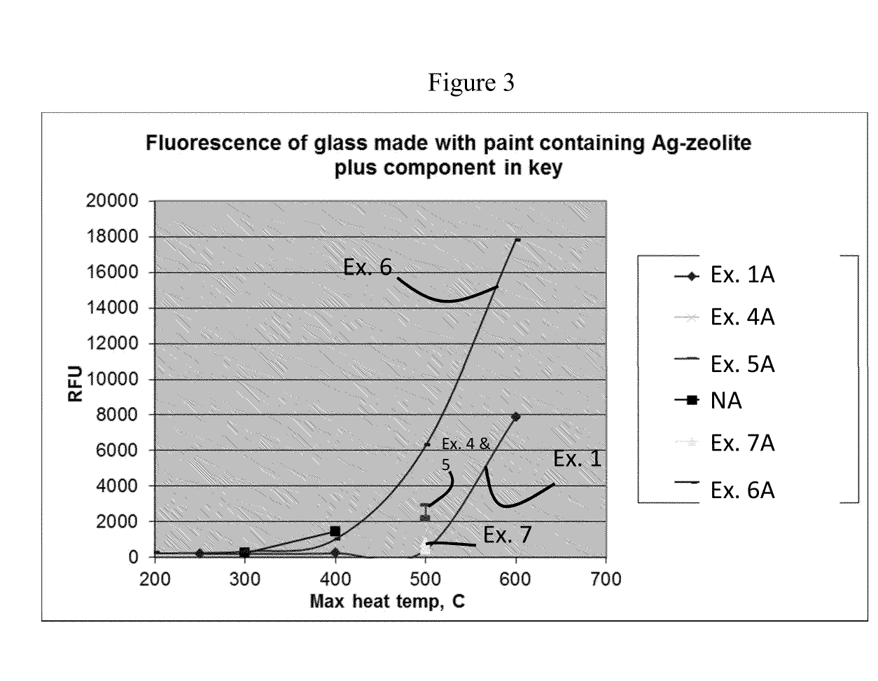

Examples 1A and 4A-7A were evaluated for fluorescence as shown in FIG. 3. The degree of fluorescence is relative to the amount of Ag¹⁺ species in the glass substrate. As shown in FIG. 3, Example 6A (which included only Ag-zeolite and AgNO₃, without an organic binder) exhibited the highest fluorescence.

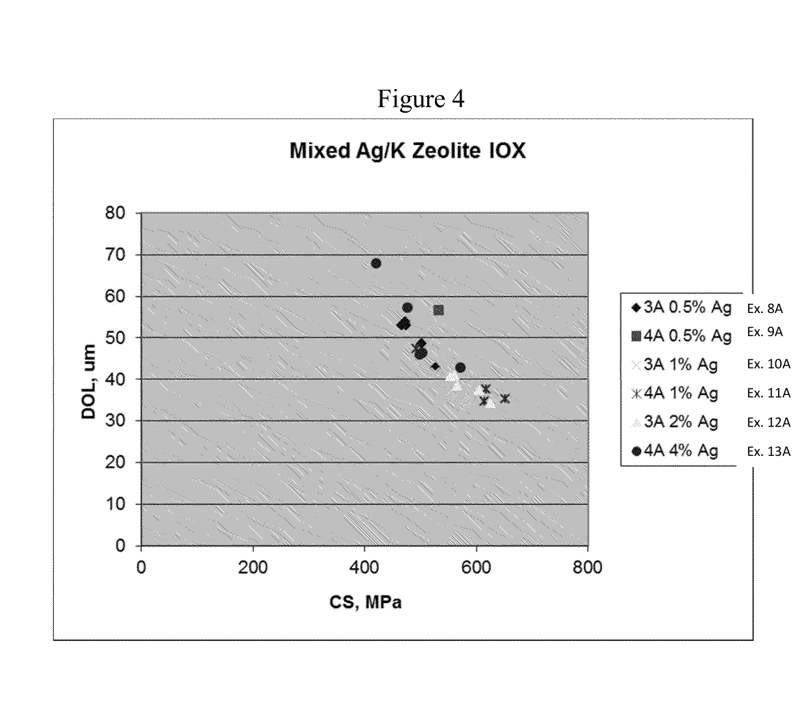

Examples 8A-13A were made using 3A zeolite particles and 4A zeolite particles. The 3A zeolite particles included K+ ions without modification. The 4A zeolite particles were modified to include K+ ions. The zeolite particles were exposed to a Ag-salt solution (in the case of the 3A zeolite particles) or an K and Ag salt solution (in the case of 4A zeolite particles) with agitation, separated the liquid and solid and dried in a convection oven at 100° C. to form either 3A Ag-zeolite particles or 4A Ag-K-zeolite particles. The zeolite particles were then combined with a solvent including water and KNO₃ to form antimicrobial agent-containing suspensions having a zeolite particle concentration in the range from about 0.5% to about 4%. Glass substrates were contacted on both major surfaces with the antimicrobial agent-containing suspensions and heated to 400° C. for about 8 hours. The compressive stress and depths of compressive stress layers were measured using FSM and shown in FIG. 4. As shown in FIG. 4, both forms of zeolite particles (i.e., 3A zeolite particles and 4A zeolite particles) resulted in articles including a compressive stress in the range from about 500 MPa to about 610 MPa and depths of compressive stress layers in the range from about 32 μm to about 69 μm. FIG. 4 only shows the data gathered from articles made from up to 4% zeolite particles, as higher particle concentrations were not readable using FSM. It is believed that even higher compressive stress values can be obtained by placing the substrates with the antimicrobial agent-containing suspensions in a preheated furnace and removing such substrates while they are still hot (instead of allowing the substrates to heat and cool at various rates).

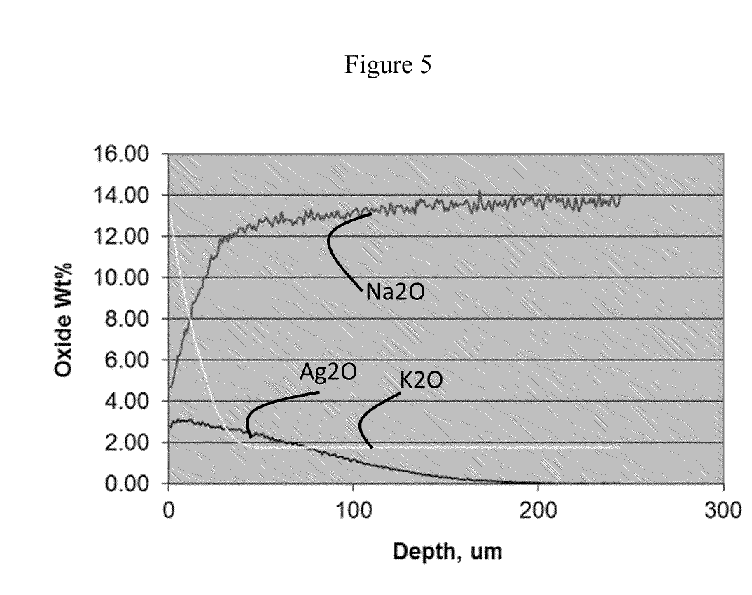

Example 14A was formed in the same manner as Examples 8A-13A however the antimicrobial agent-containing suspension included 25% Ag-zeolite (3A zeolite particle). The antimicrobial agent-containing suspension was applied to both sides of the glass substrate and heated to 400° C. for 8 hours. One side of Example 14 was analyzed by electron microprobe for depth of silver, sodium and potassium. FIG. 5 shows the change in those elements with depth and specifically shows that potassium exchanges primarily for sodium in the glass.

### Example B

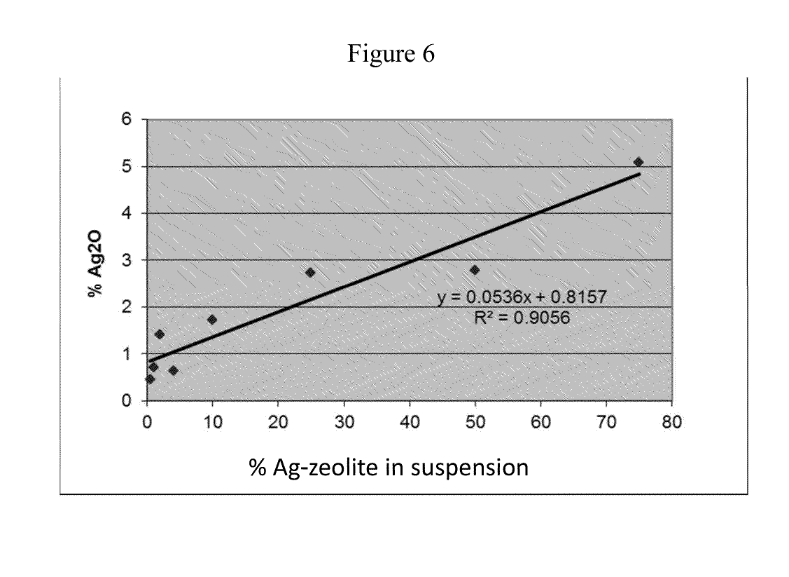

Samples formed according to Example B shows the change in concentration of Ag₂O in the substrate with different concentrations of Ag-zeolite particles. For each sample, antimicrobial agent-containing suspensions having a concentration of Ag-zeolite particles in the range from about 0.5% to about 75% were prepared and contacted with glass substrates for 8 hours at 400° C. As shown in FIG. 6, the amount of Ag₂O in the surface of the glass (i.e. from the surface to a depth of about 1 μm), increases substantially linearly with the % Ag-zeolite in the suspension. As shown in FIG. 6, the surface of the glasses included from about 0.45 wt % to about 5.09 wt % Ag₂O.

The samples according Example B were evaluated for antimicrobial efficacy. As shown in Table 2, the samples exhibited greater than 10 3 kill (or a reduction of greater than 99.9%_of E. coli bacteria under “wet” conditions (according to the JIS Z 2801 test).

TABLE 2
Antimicrobial efficacy under “wet” conditions
(according to the JIS Z 2801 test) for Example B.

| % Ag- | |
|---|---|
| zeolite | Log kill |
| 0.5 | 3.53 |
| 1 | >5 |
| 2 | 4.01 |
| 10 | >5 |
| 25 | >3 |
| 50 | >3 |
| 75 | >3 |

### Examples 1C-4C

Examples 1 C-4C were formed by contacting glass substrates with antimicrobial agent-containing suspension of Ag-zeolite particles, Na-zeolite particles, AgNO₃ metal salt and NaNO₃ metal salt in water, as shown in Table 3.

TABLE 3
Antimicrobial agent-containing suspensions
used to form Examples 1C-4C.

| | Ag- | Na- | | Metal salt(s) | |
|---|---|---|---|---|---|
| Example | zeolite | zeolite | Water | AgNO₃ | NaNO₃ |
| 1C | 10 g | — | 6 g | 10 g | — |
| 2C | — | 5 g | 6 g | 10 g | — |
| 3C | 10 g | 5 g | 13 g | 10 g | — |
| 4C | 10 g | — | 6 g | 5 g | 5 g |

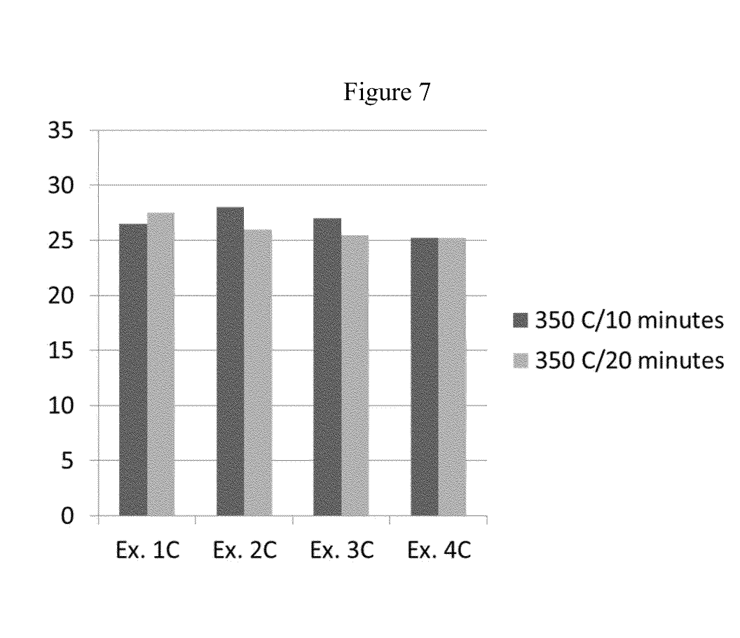

The suspensions were each contacted with a glass substrate and heated for 10 minutes or 20 minutes at 350° C. The concentration of Ag₂O at the surface of the glasses (i.e., from the surface to a depth of about 43 nm) was found to be greater than about 25 wt %, regardless of the contact time at 350° C. or the composition of the suspension, as shown in FIG. 7. The compressive stress and depth of compressive stress layer of each of Examples 1C-4C was measured before and after contact with the antimicrobial agent-containing suspension. The compressive stress and depth of compressive stress layer after contact was about 92% -96% of the compressive stress and depth of compressive stress layer before contact.

### Examples 1D & 2D

An antimicrobial agent-containing suspension was formed by forming Na-zeolite powder by agitating 50 g of 4A molecular sieve zeolite in a 400 ml solution of 0.5M copper sulfate or copper nitrate with 0.1M iron gluconate overnight. This agitation was performed a second time overnight, forming a green colored powder. About 45 g of the Cu-zeolite powder was mixed with 90 g of a solution of 2M copper nitrate and 2M urea, to form the antimicrobial agent-containing suspension.

The antimicrobial agent-containing suspension was sprayed onto glass substrates having a composition including about 70 mol % SiO₂, 8.5 mol % Al₂O₃, 14 mol % Na₂O, 1 mol % K₂O, 6.5 mol % MgO, 0.5 mol % CaO and 0.2 mol % SnO₂, to form Examples 1D. Example 2D was prepared spraying the antimicrobial-agent-containing suspension onto glass ceramic substrates including a nepheline crystal phase.

The antimicrobial agent-containing suspension formed a coating having a thickness in the range from about 100 μm to about 200 μm. The coatings were dark green and hygroscopic, and required storage in a desiccator until firing. The coated substrates were heat treated in a nitrogen atmosphere at a temperature of either about 500° C. or 650° C. for 5 minutes

Thereafter, the coating was removed. The resulting glass substrates (Example 1D) exhibited different colors such as pink, orange/red, green and amber, which may be attributable to differences in partial pressure of oxygen during firing.

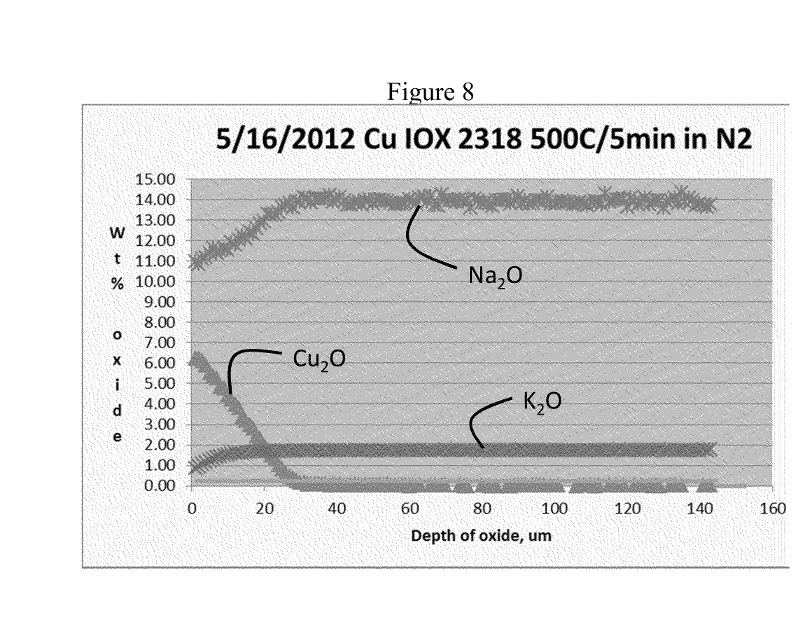

FIG. 8 is a graph showing electron microprobe data for Example 1D, after being heat treated at 500° C. for 5 min in nitrogen. FIG. 8 shows that the concentration of Cu2O is about 6 wt % at a depth of about 1 μm below the surface.

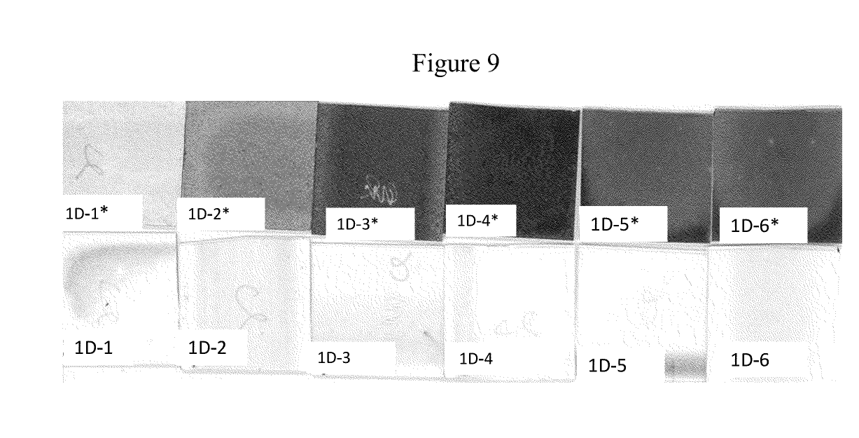

FIG. 9 shows images of Examples 1D after being heat treated at various temperatures in the range from about 350° C. to about 650° C. for 5 minutes in a nitrogen environment (indicated by 1D-1, 1D-2, 1D-3, 1D-4, 1D-5 and 1D-6), followed by washing and heat treating in hydrogen at 450° C. for 1 hour (indicated by 1D-1*, 1D-2*, 1D-3*, 1D-4*, 1D-5* and 1D-6*), as shown in Table 4.

TABLE 4
Heat treatment conditions for Examples 1D.

| Ex. | 1D-1 | 1D-2 | 1D-3 | 1D-4 | 1D-5 | 1D-6 |
|---|---|---|---|---|---|---|
| Heat treatment | 350° C. | 405° C. | 450° C. | 500° C. | 575° C. | 650° C. |
| in N₂ | | | | | | |
| Heat treatment | 450° C. | 450° C. | 450° C. | 450° C. | 450° C. | 450° C. |
| in hydrogen | | | | | | |

As shown in FIG. 9, changes in visible absorbance of light or color were observed. After firing in nitrogen at temperatures up to about 650° C., very little color was observed; however slight copper metal deposits on the glass were observed, which were easily removable using a mineral acid rinsing or rinsing using Semiclean KG detergent. Color was observed after firing in hydrogen, indicating formation of copper metal.

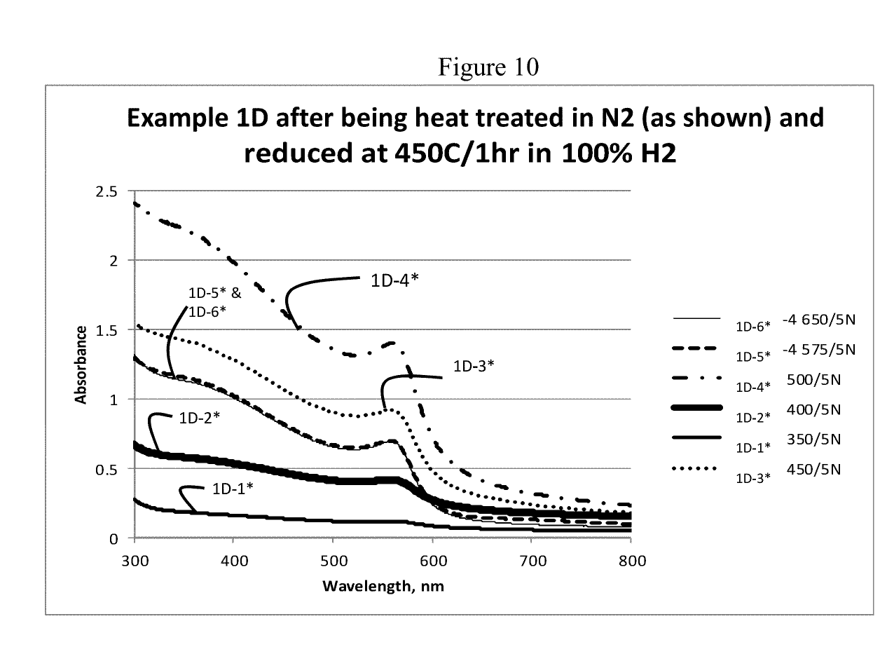

FIG. 10 is a graph of wavelength v. absorbance for Examples 1D, after various heat treatments in nitrogen. The data shown in the graph was obtained by spectrophotometry and shows a copper plasmon peak at about 56 nm for nano-metallic copper.

The glass ceramic substrates of Example 2D were contacted with the antimicrobial agent-containing suspension in the same manner as Example 1D. The coated glass ceramic substrates were heat treated at 650° C. or 700° C. for 5 minutes in a nitrogen atmosphere, and then heat treated at 450° C. for 1 hour in hydrogen. The coating was removed using a Semiclean KG detergent.

The antimicrobial efficacy of Examples 2D were evaluated using the modified JIS Z 2801 (2000) testing conditions, as described herein. Examples 2D exhibited a high log kill in a dry atmosphere, as shown in Table 5.

TABLE 5
Antimicrobial efficacy Examples 1D and 2D.

| | Heat | Heat | | | Average | | | Recovery | |
|---|---|---|---|---|---|---|---|---|---|
| | treatment | treatment | | LCL | reduction | UCL | LCL | log 10 | UCL |
| Ex. | N₂ | H₂ | Cleaning | (95%) | ratio | (95%) | (95%) | difference | (95%) |
| 2D | 600° C./5 | 450° C./ | Semiclean | 98.5% | 99.5% | 100.0% | 1.83 | 2.27 | 2.71 |
| | minutes | 1 hour | KG | | | | | | |
| 2D | 700° C./5 | 450° C./ | Semiclean | 98.0% | 98.7% | 99.4% | 1.59 | 1.89 | 2.18 |
| | minutes | 1 hour | KG | | | | | | |

While the embodiments disclosed herein have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of the present disclosure or the appended claims.

What is claimed is:

1. An antimicrobial article, comprising:
a glass or glass-ceramic substrate, a compressive stress layer that extends inward from a surface of the glass or glass-ceramic substrate to a first depth therein, and an antimicrobial agent-containing region that extends inward from the surface of the glass or glass-ceramic substrate to a second depth therein, wherein the antimicrobial agent-containing region comprising at least one of a plurality of ion exchanged-copper ions and a plurality of ion exchanged-silver ions, arranged in a predetermined portion of the surface.

2. The antimicrobial article of claim 1, wherein the predetermine portion of the surface creates a geometric pattern.

3. The antimicrobial article of claim 1, further comprising an additional functional layer disposed on the surface of the glass or glass-ceramic substrate, wherein the additional functional layer comprises a reflection-resistant coating, a glare-resistant coating, fingerprint-resistant coating, smudge-resistant coating, a color-providing composition, an environmental barrier coating, or an electrically conductive coating.

4. The antimicrobial article of claim 1, wherein a compressive stress of the compressive stress layer is about 200 megapascals to about 1.2 gigapascals and the first depth is less than about 100 micrometers.

5. The antimicrobial article of claim 1, wherein the antimicrobial agent comprises a cationic monovalent silver species, cationic monovalent copper species, and/or cationic divalent zinc species.

6. The antimicrobial article of claim 1, wherein the second depth is about 5 micrometers to about 200 micrometers.

7. The antimicrobial article of claim 1, wherein an antimicrobial agent concentration of an outermost 50 nanometers of the antimicrobial agent-containing region is up to about 10 weight percent, based on a total weight of the outermost 50 nanometers of the antimicrobial agent-containing region.

8. The antimicrobial article of claim 1, wherein the antimicrobial article exhibits at least one of:
a 3 log reduction or greater in a concentration of at least Staphylococcus aureus, Enterobacter aerogenes, and Pseudomomas aeruginosa bacteria under Dry Test conditions;
a 3 log reduction or greater in a concentration of at least Staphylococcus aureus, Enterobacter aerogenes, and Pseudomomas aeruginosa bacteria under JIS Z 2801 (2000) testing conditions; and
a 1 log reduction or greater in a concentration of at least Staphylococcus aureus, Enterobacter aerogenes, and Pseudomomas aeruginosa bacteria under modified JIS Z 2801 (2000) testing conditions, wherein modified conditions comprise heating the antimicrobial article to a temperature of about 23 degrees Celsius to about 37 degrees Celsius at a humidity of about 38 percent to about 42 percent for about 24 hours followed by drying for about 6 hours to about 24 hours.

9. A method of making an antimicrobial article, the method comprising:
providing a glass or glass-ceramic substrate having a compressive stress layer that extends inward from a surface of the glass or glass-ceramic substrate to a first depth; and
ion-exchanging an antimicrobial agent from an antimicrobial agent-containing liquid suspension into the glass or glass-ceramic substrate effective to form an antimicrobial agent-containing region that extends inward from the surface of the glass or glass-ceramic substrate to a second depth.

10. The method of claim 9, further comprising forming an additional functional layer on at least a portion of the surface of the glass or glass-ceramic substrate, wherein the additional functional layer comprises a reflection-resistant coating, a glare-resistant coating, fingerprint-resistant coating, smudge-resistant coating, a color-providing composition, an environmental barrier coating, or an electrically conductive coating.

11. The method of claim 10, wherein forming the additional functional layer occurs before forming the antimicrobial agent-containing region.

12. The method of claim 9, wherein providing the glass or glass-ceramic substrate having the compressive stress layer comprises:
providing the glass or glass-ceramic substrate; and
forming the compressive stress layer in the glass or glass-ceramic substrate by thermal tempering or chemical ion exchanging.

13. The method of claim 9, wherein ion-exchanging the antimicrobial agent from the antimicrobial agent-containing liquid suspension into the glass or glass-ceramic substrate comprises:
contacting at least a portion of the surface of the glass or glass-ceramic substrate with the antimicrobial agent-containing liquid suspension, wherein the antimicrobial agent-containing liquid suspension comprises a plurality of particles of a zeolite dispersed in a solvent, wherein the zeolite comprises the antimicrobial agent disposed within pores of the zeolite; and
heating the glass or glass-ceramic substrate and/or the antimicrobial agent-containing liquid suspension to a temperature of less than or equal to about 600 degrees Celsius for a period of less than or equal to about 8 hours.

14. The method of claim 13, further comprising discontinuing the contacting.

15. The method of claim 9, wherein the second depth is about 5 micrometers to about 200 micrometers.

16. The method of claim 9, wherein an antimicrobial agent concentration of an outermost 50 nanometers of the antimicrobial agent-containing region is up to about 10 weight percent, based on a total weight of the outermost 50 nanometers of the antimicrobial agent-containing region.

17. The method of claim 9, wherein the antimicrobial article exhibits at least a 3 log reduction in a concentration of at least Staphylococcus aureus, Enterobacter aerogenes, and Pseudomomas aeruginosa bacteria under JIS Z 2801 (2000) testing conditions.

18. The method of claim 9, wherein the antimicrobial article exhibits at least a 1 log reduction in a concentration of at least Staphylococcus aureus, Enterobacter aerogenes, and Pseudomomas aeruginosa bacteria under modified JIS Z 2801 (2000) testing conditions, wherein modified conditions comprise heating the antimicrobial article to a temperature of about 23 degrees Celsius to about 37 degrees Celsius at a humidity of about 38 percent to about 42 percent for about 24 hours followed by drying for about 6 hours to about 24 hours.

19. The method of claim 9, wherein the antimicrobial article exhibits at least a 3 log reduction in a concentration of at least Staphylococcus aureus, Enterobacter aerogenes, and Pseudomomas aeruginosa bacteria under Dry Test conditions.
